(19) United States
(12) Patent Application Publication
(10) Pub. No.: US 2007/0039050 A1
(43) Pub. Date: Feb. 15, 2007

(54) Web-based data collection using data collection devices

(76) Inventors: Vladimir Aksenov, Santa Barbara, CA (US); Euan G.S. Slidders, Oxnard, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/348,612

(22) Filed: Feb. 6, 2006

Related U.S. Application Data
(60) Provisional application No. 60/708,450, filed on Aug. 15, 2005.

(51) Int. Cl. G06F 12/14

(52) U.S. Cl. 726/22

(57) ABSTRACT

A mechanism for transmitting data between data collection devices and a web server over a network using capabilities provided by a web browser plugin. A web browser uses device-specific communication library to read data from and write data to the data collection devices. The data is encrypted prior to being securely transmitted between the data collection devices and the web server.

### CROSS-REFERENCE TO RELATED APPLICATIONS

This application claims the benefit of U.S. Provisional Application No. 60/708,450, entitled “Web-Based Data Collection Using Data Collection Devices”, filed Aug. 15, 2005, which is incorporated by reference herein in its entirety.

### BACKGROUND OF THE INVENTION

1. Field of the Invention

The present invention is related to transmission of data between data collection devices and a web server over a network, and more specifically, to a mechanism for transmitting data between data collection devices and a web server using capabilities provided by a web browser plugin.

2. Description of the Related Art

A number of applications exist in which monitoring of the location of physical objects is important. For example, physical asset tracking is widely carried out in both the public and private sectors to guard against theft and other forms of loss and misuse.

Traditionally, devices such as bar code scanners, Radio Frequency Identification (RFID) tags and the like are used to scan or detect the location of the assets. The tracking data is then transferred to a computer, typically through connection to an RS232 or Universal Serial Bus (USB) port of the computer. The data can then be used to prepare reports as needed.

One conventional approach to transmitting data from data collection devices to a server over the Internet is using serial-over IP or USB-over-IP protocol converters (COM port redirectors) offered by companies such as Digi (http://www.digi.com). Referring now to FIG. 6, a prior art system 600 for transmitting data from data collection devices over the Internet is shown. System 600 includes a web server 610 in communication with a plurality of data collection devices 620a through 620n. This approach allows port 1 through port n, created by COM port redirector driver 680, talk to data collection devices 620a through 620n across the Internet 670. However, this approach does not scale well for the following reasons. When a new device is added to the system, a new port has to be created. Some operating systems, however, place a limit on the number of ports. Further, adding a new data collection device requires configuration of the web server, which is not desirable.

Another conventional approach is having a standalone application operating on a user's computer, either directly communicating with a web server or further requiring files to be uploaded manually. This approach, however, requires manual installation of software at the user's computer, which can be impractical and tedious.

Accordingly, there is a need for a mechanism for transmitting data between data collection devices and a server over a network that overcomes limitations of prior art techniques.

### SUMMARY

The present invention provides a mechanism for transmitting data between data collection devices and a server over a network using capabilities provided by a web browser plugin.

A client device, such as a computer located nearby to the data collection devices, captures data from the data collection devices and transmits the data to a web server over a network, such as the Internet. The client device executes a web browser, a web browser plugin module, a communication library, and a communication module, such as a JavaScript module. The plugin module uses the device-specific communication library to read or write data to the data collection devices. The plugin module receives the data from the communication library and encrypts the data. The communication module provides an interface between the web browser and the plugin module and submits the encrypted data to the web browser. The web browser, in turn, posts the encrypted data to the web server. The web server receives the encrypted data, decrypts the data, and stores the data to an appropriate server.

The present invention also supports uploading data from the web server to a data collection device. The web server encrypts the data and creates a digital signature of the data before sending it to the client. The plugin module on the client device receives and decrypts the data, and verifies data integrity to ensure that the data has not been changed while en route from the web server to the client device. Once the authenticity of the data is established, the communication library writes the data to the data collection device.

The present invention thus enables a scalable, secure solution that does not require special configuration on a client device or on a web server.

The features and advantages described in this summary and the following detailed description are not all-inclusive. Many additional features and advantages will be apparent to one of ordinary skill in the art in view of the drawings, specification, and claims thereof. Moreover, it should be noted that the language used in this disclosure has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 illustrates an overview of a system for transmitting over a network data collected by a data collection device in accordance with an embodiment of the present invention.

FIG. 2 is a block diagram of the components of a web browser executed on a client device according to an embodiment of the present invention.

FIG. 3 is a block diagram of the components of a web server in accordance with an embodiment of the present invention.

FIG. 4 is an event diagram of a process of downloading data from a data collection device according to an embodiment of the present invention.

FIG. 5 is an event diagram of a process of uploading data to a data collection device according to an embodiment of the present invention.

FIG. 6 is a diagram illustrating a prior art method of transmitting data between data collection devices and a server.

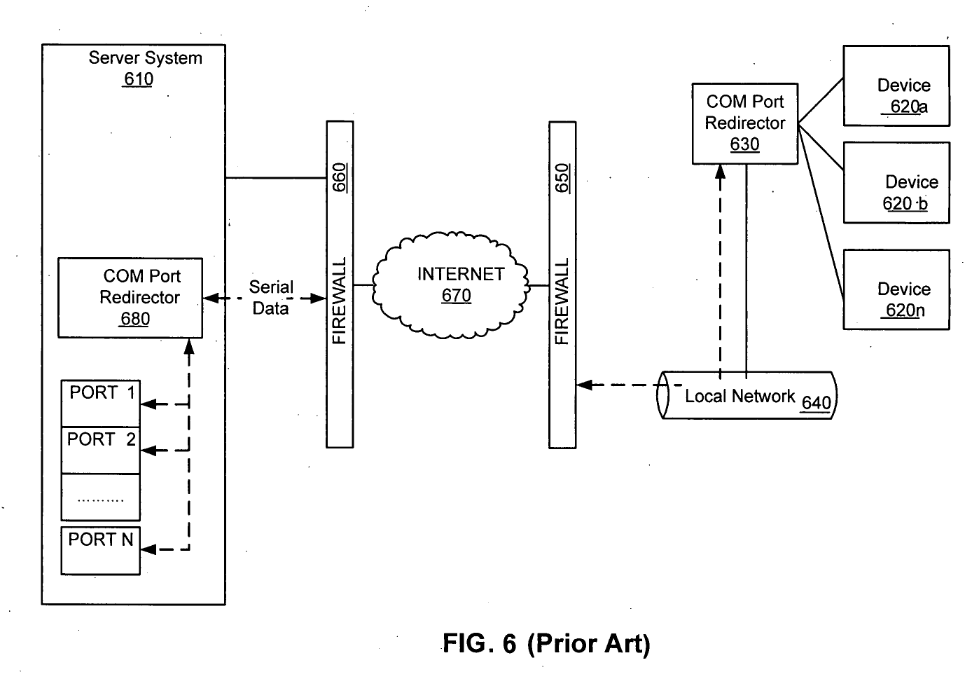

### DETAILED DESCRIPTION OF THE PREFERRED EMBODIMENTS

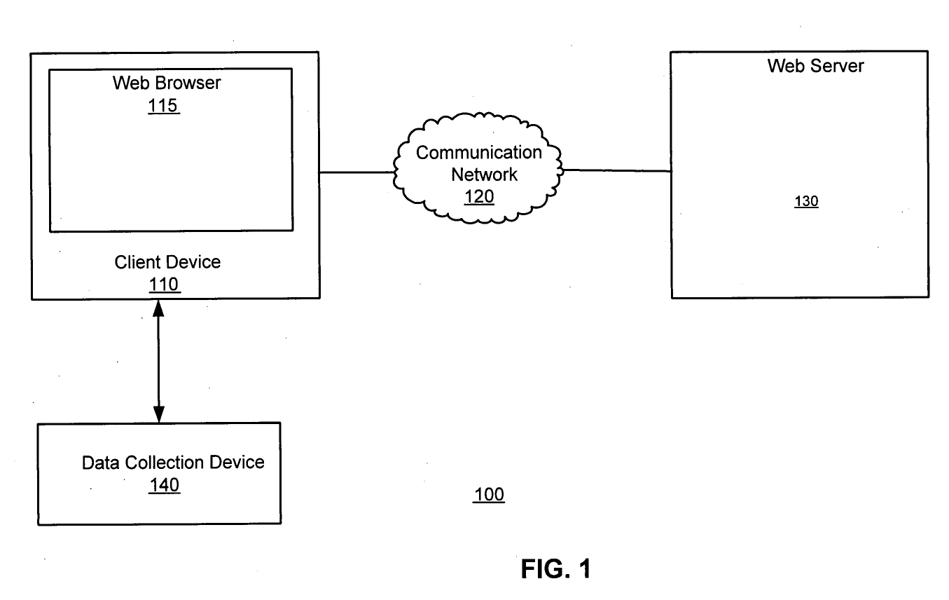

FIG. 1 is an overview of a system 100 for transmitting data between a data collection device 140 and a web server 130 using a web browser 115 according to an embodiment of the present invention. System 100 also includes a client device 110 associated with a user and connected to a web server 130 by a communication network 120.

Data collection device 140 is used to collect data such as might be found at locations remote from web server system 130. For example, data collection device 140 may be used to scan bar code labels in a factory or office environment in order to track inventory. Alternatively, the device 140 may be designed to collect data from Radio Frequency Identification (RFID) tags, or other data formats. One example of a bar code scanner is the LaserLite by Videx of Corvalis, Oreg. An example of an RFID reader is the BlueCard by Blue Card Software Technology Co., Ltd., of Beijing, China. Those of skill in the art will appreciate that many types of data collection devices exist, each designed to capture data and transfer the data to a computer for further processing.

Client device 110 is a conventional computer or other electronic appliance on which a web browser can be used. Client device 110 downloads data from data collection device 140, encrypts the received data, and submits the received data to web server 130. The present invention also supports uploading data from the web server 130 to data collection devices 140. Client device 110 also uploads data to the data collection device 140, for example to provide updated firmware to the device.

Client device 110 executes the web browser 115 for interpreting HyperText Markup Language (HTML) or other display instructions in a web page and displaying the content accordingly. Web browser 115 includes additional functionality, such as a Java Virtual Machine, for executing JAVA® applets, ActiveX®, Flash®, and other applets and scripts technologies. The term “module” refers to computer program code and/or hardware adapted to provide the functionality attributed to the module, and which may have any type of implementation, for example, as a library file, script, object code, class, package, applet, and so forth.

Web server 130 receives data from client device 110, decrypts the received data, and stores the received data to an appropriate web server, such as a database server (not shown in FIG. 1). Communication network 120 in one embodiment is the Internet, but may be any network over which web server 130 and client 110 can communicate.

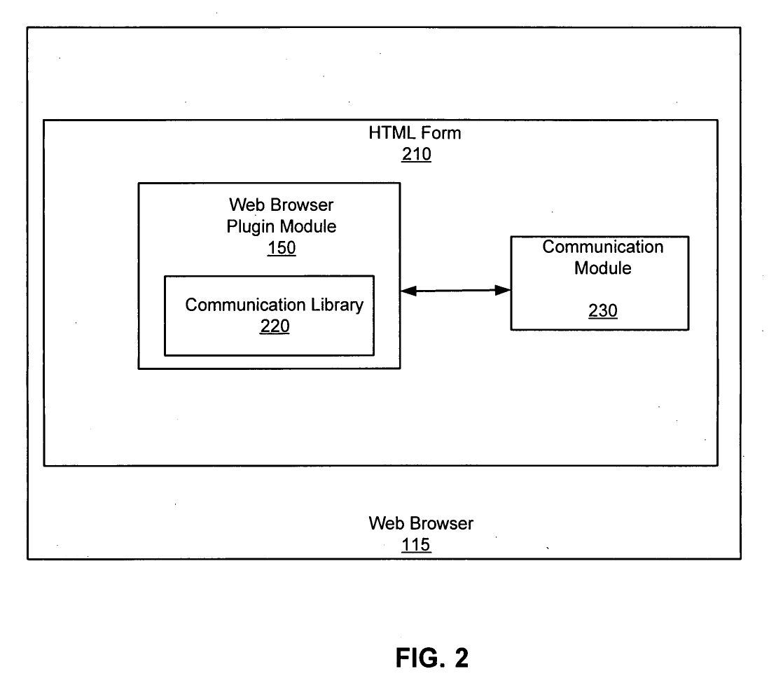

FIG. 2 illustrates components of web browser 115 in one embodiment. Web browser 115 renders an HTML form 210 provided by web server 130 in order to allow data retrieved from data collection device 140 to be transmitted from client device 110 to web server system 130. HTML form 210 includes various fields, e.g., text fields and hidden fields. As is known in the art, hidden fields are used to transmit information not entered by a user. In one implementation, HTML form 210 includes the following hidden fields: a session key field, a data field, and a command field (these fields are not shown in FIG. 2).

The session key field holds a session key. In one implementation, the session key is generated by a plugin module 150 during the data download process. During the data upload process, the session key is generated by web server 130. In one embodiment the session key is generated using a random number generation algorithm.

The data field holds data uploaded from data collection device 140. Data can be, for example, RFID tags, bar code, or any other data collected by data collection device 140.

The command field holds various commands, such as “download” and “upload.”

HTML form 210 further includes plugin module 150. Plugin module 150 verifies data integrity during the process of uploading data to data collection device 140.

Plugin module includes communication library 220. Communication library 220 uses a device-specific protocol to read data from the data collection device 140 and to write data to the device 140. Communication library 220 exchanges data with data collection device 140 over a local interface, such as RS232, USB, etc.

HTML form 210 further includes a communication module 230. Communication module 230 in one embodiment is a JavaScript module embedded in HTML form 210, and is adapted to communicate data and commands between plugin module 150 and HTML form 210. Communication module 230 is further adapted to respond to events generated by plugin module 150 and web browser 115.

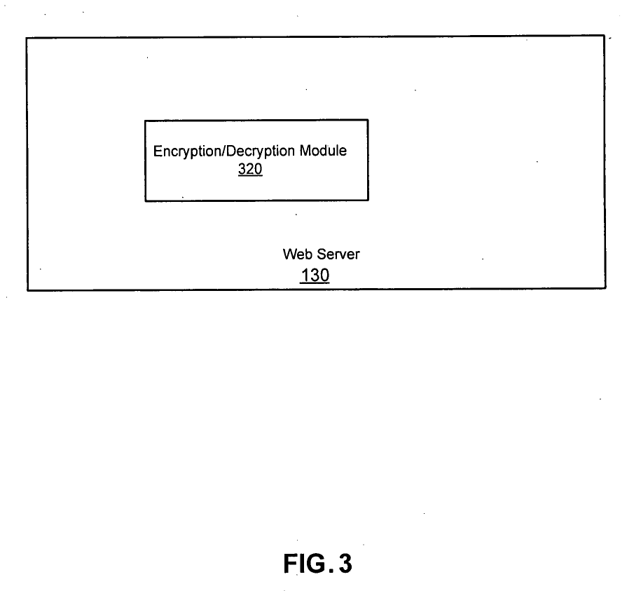

Referring to FIG. 3, a block diagram of the component of web server 130 is shown. The web server 130 is an application for serving web pages across communication network 120. Web server 130 can be, for example, Microsoft Internet Information Server (IIS), Apache, or any other system capable of serving web pages across communication network 120. Web server 130 includes an encryption/decryption module 320. Encryption/decryption module 320 provides encryption and decryption functionality that can be implemented in hardware, firmware, and/or software, for example using DES, IDEA, Blowfish, RSA, Triple DES, RC2 or other encryption. algorithms.

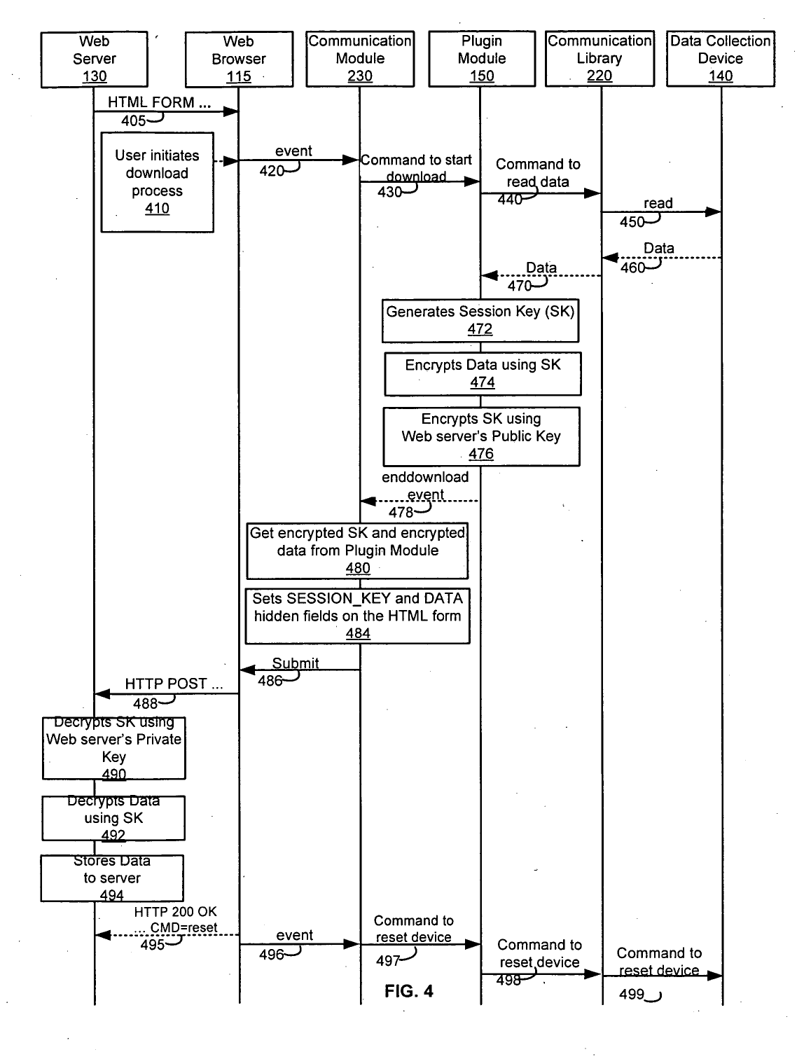

FIG. 4 is an event diagram illustrating exemplary transactions performed by web server 130, web browser 115, communication module 230, plugin module 150, and data collection device 140 to download data from data collection device 140 according to an embodiment of the present invention. It should be noted that not every communication between the entities is shown in FIG. 4. In other embodiments of the present invention, the order of the communication can vary.

Initially, web browser 115 renders 405 HTML form 210 provided by web server 130. As previously described, HTML form 210 includes various hidden fields. A user at the client device 110 initiates 410 a downloading process. In one implementation, a user clicks a “start download” or other similar command on HTML form 210. The web browser 115 then generates an event and sends 420 the event to communication module 230. Communication module 230 captures the event and invokes 430 plugin module 150. Plugin module 150, in turn, calls 440 a method of communication library 220 to read the data from the data collection device 140.

Communication library 220 uses a device-specific protocol to exchange data with data collection device 140. Communication library 220 issues 450 a command to read the data from data collection device 140. Data collection device 140 sends 460 the data over a local interface to communication library 220. Communication library 220 transmits 470 the received data to plugin module 150.

Plugin module 150 receives the data and generates 472 a session key (SK) using a random number generation algorithm. Plugin module 150 then encrypts 474 the received data using the session key. In one implementation, plugin module 150 uses the Advanced Encryption Standard (AES) algorithm to encrypt the data. A person of ordinary skill in the art would understand that any symmetric encryption algorithm can be used to encrypt the data.

At step 476, plugin module 150 encrypts the session key using a public key of the web server 130. In one implementation, plugin module 150 uses the RSA algorithm to encrypt the session key. A person of ordinary skill in the art would understand that any public-key encryption algorithm can be used to encrypt the session key. The data is encrypted by the plugin module 150 so that it can not be intercepted or modified while en route from the client device 110 to web server 130.

Communication module 230 receives 480 the encrypted session key and encrypted data from plugin module 150. At step 484, communication module 230 sets the session key field to the encrypted session key on the HTML form 210. Communication module 230 sets the data field to the encrypted data on the HTML form 210. Communication module 230 submits 486 the HTML form 210 to web browser 115. The HTML form 210 includes the encrypted session key and encrypted data. Web browser 115 posts the encrypted data and the session key to web server 130 via, for example, the HTTP POST command.

Web server 130 invokes encryption/decryption module 320 to decrypt 490 the session key using web server's 115 private key. Module 320 decrypts the session key using the same algorithm that was used to encrypt the session key. Web server 130 further invokes encryption/decryption module 320 to decrypt 492 data using the session key. Web server 130 stores the decrypted data to an appropriate web server, such as a database server (not shown).

At step 495, the web server 130 communicates to web browser 115 the status of the data upload process. In one embodiment, web server 130 sends an acknowledgement such as an “HTTP 200 OK” message including a reset parameter, e.g., CMD=reset, to the web browser 115. This results in an event being sent 496 from the web browser 115 to communication module 230, which in turn, sends 497 a command to the plugin module 150 to reset data collection device 140. Plugin module 150 passes 498 the command to communication library 220. Communication library 220 ultimately sends 499 the command to reset data collection device 140 to the data collection device 140.

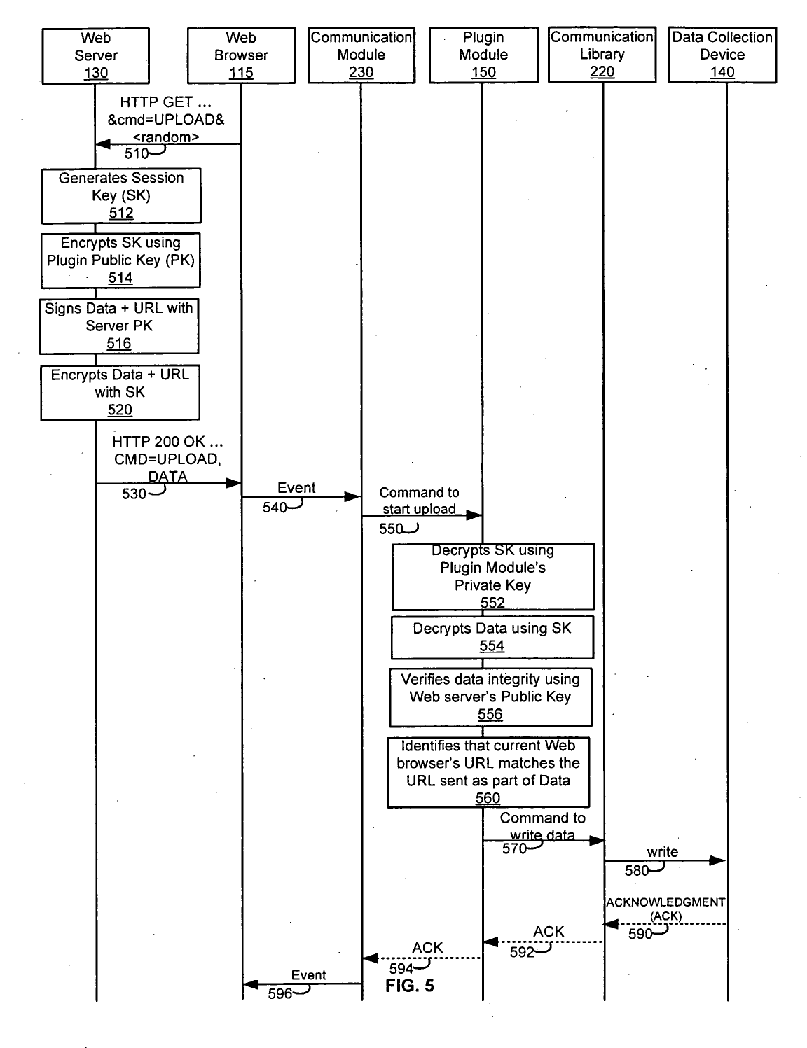

FIG. 5 is an event diagram illustrating exemplary transactions performed by web server 130, web browser 115, and data collection device 140 to upload data to data collection device 140 from web server 130 according to an embodiment of the present invention. It should be noted that not every communication between the entities is shown in FIG. 5. In other embodiments of the present invention, the order of the communication can vary.

The process is initiated by web browser 115 issuing a request, such as an HTTP GET command, to the web server 130 to upload data. The request also includes a public key of plugin module 150. The web server 130 generates 512 a session key using a random number generation algorithm. Web server 130 invokes encryption/decryption module 320 to encrypt 514 the session key using the public key of the plugin module 150. In one implementation, encryption/decryption module 320 uses the RSA algorithm to encrypt the session key. A person of ordinary skill in the art would understand that any public-key technology available now or in the future can be used to encrypt the session key.

At step 516, web server 130 signs the data and a URL of the HTML form 210 with the web server's 130 private key. To this end, web server 130 invokes encryption/decryption module 320 to generate a hash value of the data and the URL. In one implementation, SHA-1 algorithm is used to generate a hash value. A person of ordinary skill in the art would understand any hash algorithm can be used to generate a hash value. Once the hash value is generated, it is encrypted with the web server's 130 private key. In one implementation, the encryption is performed using the AES algorithm, although any symmetric encryption technology can be used to encrypt the hash value. The encrypted hash value is referred to as the “digital signature.”

At step 520, web server 130 invokes encryption/decryption module 320 to encrypt the data and the URL with the session key. In one implementation, module 320 uses the AES algorithm to perform data encryption.

The web server 130 then sends 530 a message, such as, for example, “HTTP 200 OK . . . CMD=UPLOAD” command, to web browser 115. The web browser 115 sets a command field in the HTML form 210 to the upload command. The message includes the HTML form 210 with the encrypted data and the URL and the digital signature. The web browser 115 sends 540 an event to communication module 230. Communication module 230 calls 550 a method of plugin module 150 to start uploading data to data collection device 140.

Plugin module 150 receives the encrypted data and the session key and decrypts 552 the session key using plugin module's 150 private key. Plugin module then decrypts 554 the data in the HTML form 210 with the session key using the same symmetric algorithm used by web server 130 to encrypt the data. The plugin module 150 then verifies 556 the data integrity using the web server's 130 public key. To this end, in one embodiment, plugin module 150 decrypts the received hash value of the data and the URL. Plugin module 150 calculates a hash value of the data and the URL using the same hash algorithm used by web server 130 to generate a hash value of the data and the URL. Plugin module 150 compares the calculated hash value with the decrypted hash value calculated at web server 130. If the two match, it indicates that the received data is authentic and has not been changed while being transmitted from web server 130 to client device 110.

Plugin module 150 also identifies 560 whether the URL of the web browser 115 matches the URL sent from web server 130. If the two URLs match and the data has not been changed, plugin module 150 sends 570 a command to the communication library 220 to write data to data collection device 140. Communication library 220 writes 580 data to the data collection device 140.

If device 140 acknowledges that data was successfully written to device 140, the acknowledgement (ACK) is passed 590 back to the communication library 220. The communication library 220 passes 592 the command to plugin module 150. Plugin module 150 passes 594 the command to communication module 230. Communication module 230 sends 596 an event to the web browser 115 indicating that the data has been uploaded.

Thus, the present invention utilizes existing capabilities of a web browser 115 to transmit data between data collection devices 140 and a web server 130 over a network 120. The present invention thus enables a scalable, secure solution that does not require special configuration on a client device 110 or on a web server 130. Further, the present invention does not require manual software installation on the client device 110. The data gets encrypted so that is cannot be intercepted while en route from the web server 130 to the client device 110.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the preferred embodiments of the present invention in terms of algorithms and symbolic representations of operations on information. These algorithmic descriptions and representations are the means used by those skilled in the art of computerized cartography to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A system for transmitting data between a data collection device, a client device, and a web server over a network, the system comprising:
a web browser executed at the client device, the web browser configured to render an HTML form having a first data field;
a communication library executed at the web browser, the communication library configured to read the data from the data collection device;
a web browser plugin module configured to receive and encrypt the data read by the communication library; and
a communication module executed at the web browser configured to:
receive the encrypted data from the web browser plugin module,
set the first data field in the HTML form to the encrypted data, and
submit the HTML form with the encrypted data to the web server.

2. The system of claim 1, wherein the web server generates a public key and the web browser plugin module is further configured to:
generate a session key,
encrypt the data using the session key,
encrypt the session key using the web server's public key, and
submit the HTML form with the encrypted session key to the web server.

3. A system for transmitting data between a data collection device, a client device, and a web server over a network, the system comprising:
a web browser plugin module executed at the client device, the web browser plugin module adapted to receive encrypted data and a digital signature of the data from the web server, to decrypt the received data, to verify data integrity using the digital signature, and to provide an indication of whether the data integrity has been verified; and
a communication library executed at the client device, the communication library adapted to:
receive the decrypted data and the indication of whether the data integrity is verified, and
in response to the data integrity being verified, to write the data to the data collection device.

4. A method for transmitting data between a data collection device, a client device, and a web server over a network, the method performed by a web browser, a web browser plugin module, and a communication library executed on the client device, the method comprising:
rendering, by the web browser, an HTML form having a first hidden data field;
reading, by the communication library executed at the web browser, data from the data collection device;
encrypting, by the web browser plugin module, data read by the communication library;
receiving, by a communication module executed at the client device, the encrypted data to be written to the data collection device;
setting the first data field in the HTML form to the encrypted data; and
submitting the HTML form with the encrypted data to the web server.

5. The method of claim 4, wherein the HTML form has a second hidden data field, the method further comprising:
generating, by the browser plugin module, a session key;
encrypting the session key with the web server's public key;
setting, by the web browser, the second hidden data field in the HTML form to the encrypted session key; and
sending, by the web browser, the encrypted session key to the web server.

6. The method of claim 4, wherein the step of encrypting the data is performed using symmetric encryption.

7. The method of claim 5, wherein the step of encrypting the session key is performed using public-key encryption.

8. A method for transmitting data between a data collection device, a client device, and a web server over a network, the method performed by a web browser, a web browser plugin module, and a communication library executed at the client device, the method comprising:
receiving, by the web browser from the web server, encrypted data and an encrypted hash value of the data;
decrypting, by the web browser plugin module, the encrypted data;
verifying the data integrity; and
responsive to the data integrity being verified, writing, by the communication library, the data to the data collection device.

9. The method of claim 8, wherein the step of verifying the data integrity further comprises:
decrypting the hash value of the data;
calculating, by the web browser plugin module a hash value of the data;
comparing the calculated hash value with the decrypted hash value of the data; and
responsive to the calculated hash value of the data matching the decrypted hash value of the data, writing, by the communication library, the data to the data collection device.
